(19) United States
(12) Patent Application Publication
(10) Pub. No.: US 2012/0222916 A1
(43) Pub. Date: Sep. 6, 2012

(54) Hydraulic Vehicle Lift System

(75) Inventor: Roland Hornstein, Pfalzgrafenweiler (DE)

(73) Assignee: ROLAND HORNSTEIN GMBH & CO. KG, PFALZGRAFENWEILER (DE)

(21) Appl. No.: 13/508,543

(22) PCT Filed: Nov. 9, 2010
(86) PCT No.: PCT/DE2010/001305

§ 371 Date: May 8, 2012

(30) Foreign Application Priority Data
Nov. 12, 2009 (DE) 10 2009 052 977.2

(51) Int. Cl. B66F 7/20

(52) U.S. Cl. 187/210

(57) ABSTRACT

A hydraulic vehicle lift system includes at least one hydraulic vehicle life and one hydraulic drive unit for lifting and lowering the at least one vehicle life. The hydraulic vehicle lift system is characterized in that the hydraulic vehicle lift system has at least one further hydraulic vehicle lift and at least one further hydraulic drive unit for lifting and lowering the at least one further hydraulic vehicle lift, and in that the hydraulic vehicle lifts can be hydraulically connected to the respective other hydraulic drive unit in order to be lifted and lowered.

### FIELD OF THE INVENTION

The present invention relates to a hydraulic vehicle lift system that can consist of a different number of hydraulic vehicle lifts. These are connected to one another by a hydraulic line system

### BACKGROUND OF THE INVENTION

Vehicle lifts are deployed, for example, in motor vehicle workshops for lifting vehicles for repair and maintenance purposes. The invention shall be described with reference to hydraulic two-column floor-mounted lifts and two-post floor-recessed lifts, without being limited to said lifts.

Two-column floor-mounted lifts consist of, among other things, two columns anchored to the floor “above ground.” Hydraulic cylinders are integrated in these columns which execute the lifting and lowering motions.

Two-post floor-recessed lifts consist of, among other things, two hydraulic cylinders built into the floor “below ground”, and they are fully lowered into the floor when in the retracted position.

Various designs for hydraulic vehicle lifts of the type specified above already exist. In the majority of embodiments, each lift contains a control unit and a drive unit. The drive unit is normally a hydraulic aggregate consisting of an electric motor, a hydraulic pump, a reservoir for the hydraulic fluid as well as diverse hydraulic valves and hydraulic components. The drive unit is connected by means of hydraulic lines and/or hydraulic hoses to the hydraulic cylinders of the vehicle lift.

The control unit consists of one or more actuating members or control elements with which raising, holding, and lowering functions are executed. In most cases, the electric motor is also switched on with the lifting actuating member, such that the hydraulic pump conveys hydraulic fluid to the hydraulic cylinder and raises the lift. The lowering of the lift usually takes place without switching on the electric motor. With the lowering actuating member, merely one or more hydraulic valves are either directly—i.e. manually operated—opened, or indirectly, i.e. using an external power source, pneumatically or electrically controlled, such that the hydraulic fluid can flow back into the reservoir as a result of the effective gravity, and the lift descends. In some cases, a mechanical lowering safeguard is also unlocked with the lowering actuating member. Without its being unlocked, the lift cannot be lowered.

A common design for a hydraulic vehicle lift is the so-called “compact design” in which both functions—drive and control—are disposed in a shared assembly. For two-post floor-recessed lifts, this assembly may be located on one of the walls adjacent to the lift workspace or on a free-standing console, for example. For the two-column floor-mounted lifts, this “compact design” is constructed such that the drive and control units are located directly on one of the two columns.

The drive and control units can also be disposed separately—spatially separated from one another. With two-post floor-recessed lifts, the drive unit may be located between the two hydraulic cylinders below the floor in a so-called installation cassette, for example. The control unit, however, can again be installed on one of the walls adjacent to the lift workspace or on a free standing console. The utility model G 90 03 685.9 depicts an embodiment of this type.

In another design, with two-column floor-mounted lifts, the drive unit can be located at the upper end of one of the two columns, at ca. 3 meters above the floor, for example. The control unit, however, is located at a spatial distance to the drive unit on one of the two columns at an ergonomically favorable height, ca. 1.50 meters above the floor.

These types of hydraulic vehicle lifts have two serious disadvantages: first, each of these vehicle lifts requires a drive unit. This is very expensive, particularly because the output of the drive unit in a vehicle lift is only needed on average for ca. 5-10 minutes per workday for the raising of vehicles. Second, if the drive unit breaks down, the lift can no longer raise a vehicle. When a breakdown occurs, the workplace can no longer be used, until the problem has been repaired.

Moreover, hydraulically operated lifts exist that are driven by a shared, usually centrally located, hydraulic aggregate, in which both the raising and lowering valves of the individual lifts are disposed. The raising and lowering of these lifts is carried out, respectively, through control units, which are disposed, for example, on one of the walls adjacent to the lift workspace or on a free-standing console.

The disadvantage of these types of hydraulic lifts, having a shared hydraulic aggregate, is that this design is extremely inflexible. The installation expenditure is extremely high, because for each lift an individual hydraulic line must be installed from each lift to the location of the shared hydraulic aggregate. In addition, connecting another lift at a later point in time can only be accomplished with a great deal of expenditure if the floor has to be broken open. Particularly disadvantageous, however, is that if the shared hydraulic aggregate breaks down, none of the connected lifts are functional, and a complete shutdown must be accepted.

The present invention assumes the basic objective of proposing a hydraulic vehicle lift having a new configuration and design, in which the production and installation costs are minimized and there is a significantly lower risk of shutting down.

### SUMMARY OF THE INVENTION

The hydraulic vehicle lift system according to the invention can be executed in different ways. A “smaller” vehicle lift system consists, e.g. of two vehicle lifts and two drive units, wherein the vehicle lift no. 1 is connected by means of pipe or hose lines to the drive unit no. 1; and the vehicle lift no. 2 is connected by means of pipe or hose lines to the drive unit no. 2. A “larger” vehicle lift system consists, e.g. of ten vehicle lifts and two drive units, wherein the vehicle lifts nos. 1-5 are connected by means of pipe or hose lines to the drive unit no. 1; and the vehicle lifts nos. 6-10 are connected by means of pipe or hose lines to the drive unit no. 2. The two drive units are connected at the pressure end hydraulically, wherein a valve is disposed in this connection that can be selectively opened or closed. Moreover, the two drive units are connected at the unpressurized end hydraulically in such a manner that, due to hydrostatic effects, the same reserve amount of hydraulic fluid is available in the reservoirs for both drive units, respectively.

If both drive units are functioning, the valve between both drive units is closed. Each drive unit “supplies” the directly connected vehicle lifts. If a problem occurs in one of the drive units, the valve between the two drive units is opened, and the hydraulic connection between all vehicle lifts and the functioning drive unit is thereby activated. The functioning drive unit assumes the function of the defective drive unit for raising the lifts, such that all connected vehicle lifts remain functional, even though one of the two drive units is defective.

The number of drive units and the connected vehicle lifts can be selected, and is based on the respective requirements. If, for example, six vehicle lifts are connected to one drive unit, based on a raising period of 30 sec. per instance and with an average of two lifting procedures per work hour, the operating time for the drive unit amounts to 6 minutes per hour. This corresponds to a operating period of only ten percent and represents a very low value.

With very large vehicle lift systems—e.g. having 30 or 40 vehicle lifts—the selected number of drive units can be, e.g. five, six or eight. The drive units at the pressure end and at the depressurized end are always connected to one another, however, in such a manner that each vehicle lift can be supplied by at least one second drive unit in the case of a breakdown.

An advantageous and simple design of the hydraulic vehicle lift system according to the invention is to design the circuit logic in such a manner that the control units require neither electric, nor pneumatic connection or supply lines; but instead, they are manually operated and the hydraulic medium is controlled directly. For this, at the commencement of work, the power supply for both drive units is switched on. The electric motors of both drive units start up and convey the hydraulic fluid to the control units that are closed in the neutral setting. When the hydraulic system pressure has been built up, a hydraulic-electric pressure switch shuts down the electric motor of the hydraulic aggregate. If the raising valve on a vehicle lift is opened manually, the system pressure in the line system drops temporarily. The pressure switch recognizes the loss of pressure within a few milliseconds and activates the relevant electric motor of the drive unit. The hydraulic pump conveys hydraulic fluid and the vehicle lift being operated is raised. If a lowering valve is manually operated on the control unit of a lift, then the lowering of the lift occurs by means of gravity, without an external power source and without activation of the electric motor. The hydraulic fluid flows back from the hydraulic cylinders of the vehicle lift into the reservoir of the drive unit.

Another advantageous and simple design of the hydraulic vehicle lift system according to the invention is to execute the circuit logic such that the lowering valves are operated directly, i.e. manually, but the raising valve indirectly, e.g. electrically or pneumatically. In this embodiment, the drive units receive no current in the neutral setting and the pressure lines from the drive units to the raising valves are without pressure. When a raising valve is actuated, the electric motor of the associated drive unit is simultaneously activated. The drive unit conveys hydraulic fluid and the actuated vehicle lift is raised. If the lowering valve on a control unit is manually opened, then the lowering of the vehicle lift occurs by means of gravity, without an external power source and without activation of the electric motor. The hydraulic fluid flows back from the hydraulic cylinders of the vehicle lift into the reservoir of the drive unit. If both drive units are functional, the valve in the connecting line between the two drive units is closed. Each drive unit “supplies” the directly connected vehicle lift. If one of the drive units breaks down, then the valve between the two drive units is opened, and the hydraulic connection between all of the vehicle lifts and the functional drive unit is activated at the pressure end. In addition, a control circuit is activated by means of an electric bypass circuit such that the functional drive unit can be activated by each raising valve. The same assumes the role of the defective drive unit for the raising operation such that all connected vehicle lifts remain functional, even though one of the drive units is defective.

Another advantageous design is to configure several or all of the connected lifts for shared use of sections of the line system; i.e. sections of the pressure line are designed as a pressure manifold line (“raising function”) and sections of the return flow line as the return flow manifold line (“lowering function”). This creates more flexible and more cost-effective options for the planning and project design of lift workplaces in the automotive workshop. In this manner, it is sufficient, for example, that a junction, e.g. in the form of a T-joint, be incorporated in the pressure manifold line and in the return flow manifold line for connecting a hydraulic vehicle lift thereto. The free branch of the T-joint can, for example, be designed with a plug-in connector, such that any connecting or disconnecting of the hydraulic lift at a later time can be carried out easily and without tools.

Another advantageous design is to use a fluid for the hydraulic medium that does not pollute the water supply, e.g. water with a preservative additive. This results in there being no risk to the environment, and no need to observe environmental and safety regulations for the storage and the use of water polluting fluids.

The advantages of this invention are the result of the optimized circuit logic, and of the minimization and simplification of the drive and control devices. This results in substantially lower costs in production and assembly. Moreover, greater functionality is also achieved. The probability of downtime due to defects and the demand on the availability of repair service is significantly reduced.

Other advantages of this invention are its simplicity, variability and flexibility in the planning, installation and adaptability to changing demands.

As such, it is possible, for example, to connect in a functional manner different types and models of hydraulically operated vehicle lifts of a vehicle lift product family to the drive units of the vehicle lift system according to the invention, such as, e.g. hydraulic two-post floor-recessed lifts, hydraulic two-column floor-mounted lifts and hydraulic one-post lifts. This is even possible if the vehicle lifts have different load capacities, such as e.g. 3,000 kg for passenger cars, or 3,500 kg or 5,000 kg for smaller utility vehicles.

Another advantage is that the invention results in the modernization of hydraulic vehicle lifts already in use. As such, it is possible, for example, to remove the control and drive units from existing oil-hydraulic lifts, and convert them to the vehicle lift system according to the invention. In addition to the advantages of the greater functional security, there are also the advantages of lower environmental impact. As a result, the regular monitoring and leakage testing of the built-in installation cassettes that are required with the use of a water polluting hydraulic fluid, are eliminated.

In the following, the invention shall be explained in greater detail based on the embodiment examples as depicted in the drawings.

### BRIEF DESCRIPTION OF THE DRAWINGS

FIG. 1 shows a hydraulic diagram of a hydraulic vehicle lift system.

### DETAILED DESCRIPTION OF THE PREFERRED EMBODIMENTS

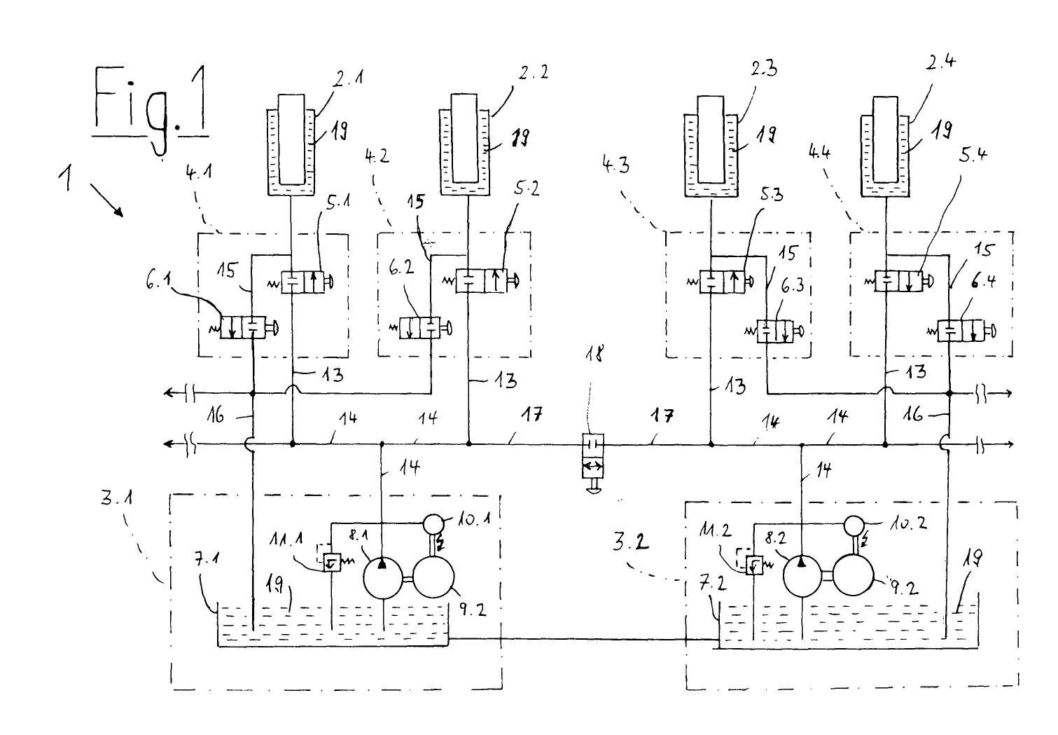

FIG. 1 shows a hydraulic vehicle lift system 1 with, by way of example, four vehicle lifts 2.1-2.4 and two drive units 3.1, 3.2, disposed in two groups. Group 1 consists of the vehicle lifts 2.1, 2.2 and the drive unit 3.1. Group 2 consists of the vehicle lifts 2.3, 2.4 and the drive unit 3.2. Each vehicle lift 2.1-2.4 is assigned to one control unit 4.1-4.4, respectively. Each control unit 4.1-4.4 has a raising valve 5.1-5.4 and a lowering valve 6.1-6.4. The drive units 3.1, 3.2 each consist of a reservoir 7.1, 7.2 for the hydraulic fluid 19, an electric motor 8.1, 8.2, a hydraulic pump 9.1, 9.2, a pressure switch 10.1, 10.2 and a pressure limit valve 11.1, 11.2. The two reservoirs 7.1, 7.2 are connected to one another by means of a line 12. For the simplification of the line system, sections of the pressure lines 13 (raising function) are executed as pressure manifold lines 14, and sections of the return flow line 15 (lowering function) are executed as return flow manifold lines 16, from which pressure lines 13 branch off to the individual lifts 2.1-2.4, or respectively, flow into the return flow lines 15 from the individual lifts 2.1-2.4. The pressure manifold lines 14 are connected to hydraulic pumps 8.1, 8.2, the return flow manifold lines 16 flow into the reservoirs 7.1, 7.2. The lifts 2.1-2.4 are connected to the pressure manifold lines 16 via their associated control units 4.1-4.4. Two groups, each containing two vehicle lifts 2.1, 2.2 and 2.3, 2.4 are formed, each group being connected to one drive unit 3.1, 3.2. The two pressure manifold lines 14 connected to the two drive units 3.1, 3.2 can be connected to one another by means of a connecting line 17 and a valve 18.

When work commences, the power source for the electric motors 10.1, 10.2 is activated, and the hydraulic pumps 9.1, 9.2 convey the hydraulic fluid 19 to the raising valves 5.1-5.4 that are closed in the neutral setting. When the hydraulic system pressure has been built up, the hydraulic-electric pressure switches 10.1, 10.2 deactivate the electric motors 8.1, 8.2. If the raising valve 5.1-5.4 on a vehicle lift 2.1-2.4 is opened manually, the system pressure in the pressure lines 13, 14 drops briefly. The pressure switches 10.1 or 10.2 recognize within a few milliseconds the drop in pressure and activate the relevant electric motor 8.1 or 8.2. The corresponding hydraulic pump 9.1, 9.2 conveys hydraulic fluid 19 and the actuated vehicle lift 2.1-2.4 is raised. If the lowering valve 6.1-6.2 on a vehicle lift 2.1-2.4 is opened manually, the lowering of the relevant vehicle lift occurs as the result of gravity, without an external power source and without activation of the electric motor 8.1, 8.2. The hydraulic fluid 19 flows from the actuated vehicle lift 2.1-2.4 back into the reservoir 7.1 or 7.2. The line 12 ensures that the same amount of hydraulic fluid 19 is present in each of the two reservoirs 7.1, 7.2.

If one of the drive units 3.1 or 3.2 becomes defective, the valve 18 is opened and the pressure manifold line 14 thereby connects the two groups of vehicle lifts 2.1-2.4 to one another. The functional drive unit 3.1 or 3.2 assumes the function of the defective drive unit 3.1 or 3.2 for the raising, such that all connected vehicle lifts 2.1-2.4 remain functional, even though one of the two drive units 3.1 or 3.2 is defective.

### LIST OF REFERENCE SYMBOLS

1 Vehicle lift system
2.1-2.4 Vehicle lift
3.1-3.2 Drive unit
4.1-4.4 Control unit
5.1-5.4 Raising valve
6.1-6.4 Lowering valve
7.1-7.2 Reservoir
8.1-8.2 Electric motor
9.1-9.2 Hydraulic pump
10.1-10.2 Pressure switch
11.1-11.2 Pressure limit valve
12 Line
13 Pressure line
14 Pressure manifold line
15 Return flow line
16 Return flow manifold line
17 Connecting line
18 Valve
19 Hydraulic fluid

1-9. (canceled)

10. A hydraulic vehicle lift system having at least one first hydraulic vehicle lift and one first hydraulic drive unit for raising and lowering the at least one first vehicle lift wherein the vehicle lift system comprises at least one additional second hydraulic vehicle lift and at least one additional second hydraulic drive unit for raising and lowering the at least one additional second hydraulic vehicle lift and wherein the hydraulic vehicle lifts for raising and lowering by hydraulic means are operatively connected such that the at least one first hydraulic drive unit can raise and lower the at least one additional second hydraulic vehicle lift and the at least one additional second hydraulic drive unit can raise and lower the at least one first hydraulic vehicle lift.

11. The hydraulic vehicle lift system according to claim 10 comprising a hydraulic connecting line between first pressure lines that are connected to the at least one first hydraulic drive unit and second pressure lines that are connected to the at least one additional second hydraulic drive unit and further comprising a valve that selectively opens and closes the hydraulic connecting line.

12. The hydraulic vehicle lift system according to claim 11 wherein sections of the first pressure lines and sections of the second pressure lines form a pressure manifold line and the hydraulic vehicle lift system further comprises return flow lines and wherein sections of the return flow lines form a return flow manifold line, wherein the pressure manifold line and the return flow manifold line operatively connect several or all of the vehicle lifts for their shared use.

13. The hydraulic vehicle lift system according to claim 11 wherein the at least one first hydraulic drive unit has a first reservoir and the at least one additional second hydraulic drive unit has a second reservoir and wherein the first and second reservoirs are connected which results in the same amount of hydraulic fluid being present in both reservoirs.

14. The hydraulic vehicle lift system according to claim 10 wherein each hydraulic drive unit is equipped with an electric motor which when activated generates a system pressure at a raising valve in a control unit that is operatively connected to a hydraulic vehicle lift.

15. The hydraulic vehicle lift system according to claim 14 wherein each electric motor is activated by a pressure switch when the system pressure falls below a preset pressure level and each electric motor is deactivated when the system pressure is at full capacity.

16. The hydraulic vehicle lift system according to claim 10 wherein each of the hydraulic drive units uses a hydraulic fluid that comprises water or water with a preservative additive.

17. The hydraulic vehicle lift system according to claim 14 wherein each electric motor can be actuated by activating a raising valve.

18. The hydraulic vehicle lift system according to claim 10 wherein each vehicle lift is lowered due to the effect of gravity when the lowering valve is activated, and the lowering of the vehicle lift occurs without involvement of the electric motors.

19. A hydraulic vehicle lift system that comprises:
(a) a first vehicle lift group comprising:
(i) a plurality of first vehicle lifts, wherein each first vehicle lift is operatively associated with a control unit that includes a raising valve and a lowering valve;
(ii) a first drive unit having a firsts reservoir containing hydraulic fluid, a first pump and first means for engaging the raising valve and the lowering valve;
(iii) a first pressure manifold that supplies hydraulic fluid to the first vehicle lifts; and
(iv) a first return flow manifold that returns hydraulic fluid to the first reservoir;
(b) a second vehicle lift group comprising:
(i) a plurality of second vehicle lifts, wherein each second vehicle lift is operatively associated with a control unit that includes a raising valve and a lowering valve;
(ii) a second drive unit having a second reservoir containing hydraulic fluid, a second pump and second means for engaging the raising valve and the lowering valve;
(iii) a second pressure manifold that supplies hydraulic fluid to the second vehicle lifts; and
(iv) a second return flow manifold that returns hydraulic fluid to the second reservoir; and
(c) a valve controlled connection line that permits fluid communication between the first and second pressure manifolds

20. The hydraulic vehicle lift system according to claim 19 wherein the first reservoir is in fluid communication with the second reservoir.

21. The hydraulic vehicle lift system according to claim 19 wherein each control unit is manually operated in order to activate a pump to raise a vehicle lift.

22. The hydraulic vehicle lift system according to claim 19 wherein each control unit is manually operated in order to lower a vehicle lift.

23. The hydraulic vehicle lift system according to claim 19 wherein the hydraulic fluid is aqueous.

24. A method of operating a hydraulic vehicle lift system, that includes multiple sets of vehicle lifts which are connected to one another by a hydraulic line system and wherein each vehicle lift is operatively associated with a control unit that includes a raising valve and a lowering valve, which comprises the steps of:
(a) pumping hydraulic fluid through the hydraulic line system to a raising valve until pressure reaches a desired limit;
(b) opening the raising valve manually to reduce the pressure whereupon a pump is activated to pump hydraulic fluid to actuate a vehicle lift; and
(c) opening the lowering valve manually to lower the vehicle lift without an external power source.

25. The method according to claim 24 wherein each set of vehicle lifts include a hydraulic fluid reservoir such that all of the hydraulic fluid reservoirs are in fluid communication with each other.

26. The method according to claim 25 wherein each set of vehicle lifts includes a pressure manifold that supplies hydraulic fluid to vehicle lifts within the set and wherein each pressure manifold is connected to at least one other pressure manifold such that hydraulic fluid from a first fluid reservoir associated with a first set of vehicle lifts can be pumped to raise vehicles lifts within a second set of vehicle lifts.

27. The method according to claim 24 wherein each set of vehicle lifts is controlled by a control unit that is manually operated.

28. The method according to claim 24 wherein each set of vehicle lifts includes a single drive unit that has a reservoir containing hydraulic fluid, a pump and means for engaging the raising valve and the lowering valve.

29. The method according to claim 28 wherein the means for engaging the raising valve and the lowering valve comprises pressure switches that actuate an electric motor to pump hydraulic fluid.
